(19) United States
(12) Patent Application Publication
(10) Pub. No.: US 2015/0090789 A1
(43) Pub. Date: Apr. 2, 2015

(54) CALCULATED COMPENSATED MAGNETIC ANTENNAS FOR DIFFERENT FREQUENCIES

(71) Applicant: HID GLOBAL GMBH, Walluf (DE)

(72) Inventors: Jurgen Kastner, Eferding (AT); Hans-Juergen Pirch, Linz (AT); Markus Pretschuh, Enns (AT)

(21) Appl. No.: 14/370,574

(22) PCT Filed: Jan. 7, 2013
(86) PCT No.: PCT/IB2013/000434

§ 371 Date: Jul. 3, 2014

Related U.S. Application Data
(60) Provisional application No. 61/583,518, filed on Jan. 5, 2012.

(51) Int. Cl. G06K 7/10; H01Q 7/00

(52) U.S. Cl. CPC G06K 7/10336; H01Q 7/00; G06K 7/10356
USPC 235/439; 343/742

(57) ABSTRACT

A compensated antenna array (108) and an RFID system including the compensated antenna array are disclosed. The antenna array includes a first antenna (208) and a second antenna (204) where the first antenna is positioned within the second antenna and overlaps itself at least one point (216) such that at least some induced current in the first antenna is offset by at least some induced current in the second antenna and such that at least some induced current in the second antenna is enhanced at the at least one point of overlap.

### CROSS-REFERENCE TO RELATED APPLICATION

This application claims the benefit of U.S. Provisional Application Ser. No. 61/583,518, filed Jan. 5, 2012, the entire contents of which are hereby incorporated herein by reference in its entirety.

### FIELD OF THE DISCLOSURE

The present disclosure is generally directed toward antennas and specifically directed toward antenna configurations for readers operating different antennas at different frequencies.

### BACKGROUND

A fundamental feature of all Radio Frequency Identification (RFID) systems is that RFID transponders and readers of a given system are sufficiently compatible to effectively communicate with one another. Compatibility is achieved in part by specifying the carrier frequency at which data signals are communicated between the RFID transponders and readers of the RFID system. There are currently two standard carrier frequencies which have been generally accepted for use in RFID systems. RFID systems, which employ RFID transponders of the type conventionally termed proximity cards or proximity tags, typically communicate by means of data signals at a carrier frequency within a range of 100 to 150 kHz. This carrier frequency range is nominally referred to herein as 125 kHz carrier frequency and is deemed low frequency in the RFID industry. In contrast, RFID systems employing RFID transponders of the type conventionally termed smart cards typically communicate by means of data signals at a carrier frequency of 13.56 MHz, which is deemed high frequency in the RFID industry. The frequency bandwidth available for use around the carrier frequency of 13.56 MHz is defined by industry-wide standards such as ISO standards 15693 and 14443.

At present, the use of RFID transponders operating at the low carrier frequency and RFID transponders operating at the high carrier frequency have proliferated throughout the world. Therefore, it is both highly desirable and a significant challenge to develop an RFID reader which is compatible with RFID transponders operating at either accepted carrier frequency and which achieves a level of performance comparable with an RFID reader optimized to operate at a single carrier frequency. As such, the present disclosure recognizes a need for an RFID system having one or more RFID readers, each of which is capable of communicating with a plurality of RFID transponders, one or more of which are operating at a different carrier frequency than the remaining RFID transponders.

The above-noted problems have been addressed in U.S. Pat. No. 7,439,862 to Quan, the entire contents of which are hereby incorporated herein by reference. The present disclosure further builds upon the inventive aspects of the '862 patent.

### SUMMARY

One aspect of the present disclosure is that two radiating antennas of different frequencies (e.g. Low Frequency—125 kHz and High Frequency—13.56 MHz) are calculated and arranged in such a way that there is minimal to no coupling between the antennas. As used herein, the term “radiating antennas” may be used to indicate that both antennas are active transmitters and generate a magnetic field on their own, either at the same time or sequentially. In general, the usage of the same frequency at both antennas is feasible, however, the disclosure provided herein will primarily focus on antennas operating at different frequencies. It should be appreciated, however, that embodiments of the present disclosure are not limited to antennas operating at different frequencies.

An embodiment of the present disclosure provides an antenna array with a first antenna and second compensated antenna. The first antenna comprises a zero or traditional loop shape while the second antenna comprises an eight-shape or figure eight. It should be appreciated that the first and/or second antenna may comprise one, two, three, four, twenty, or more windings or turns without departing from the scope of the present disclosure. For simplicity, however, embodiments of the present disclosure will often refer to single turn antennas. The number of turns or windings in an antenna should not be limited based on the examples discussed herein.

Another embodiment of the present disclosure provides an antenna array with two overlaying and emitting magnetic antennas of different technologies (e.g., different carrier frequencies) in one reader product or housing. The antennas may be printed with conductive ink on a plastic or paper substrate, established on a Printed Circuit Board (PCB), wired, or any combination thereof. Aspects of the present disclosure can achieve compensated antennas with any number of antenna production methodologies.

Because of the special arrangement of the turns from the first antenna compared to the second antenna, the induced current between the antennas becomes substantially negligible. Because of this effect, substantially no noise from the antennas in the antenna array is induced back to the active antenna (e.g., the antenna in the antenna array that is currently active or coupled with an RFID tag).

Other embodiments of the present disclosure provide antenna arrays that achieve substantially similar effects as the zero/figure eight antenna array configuration. As one non-limiting example, an antenna array where one of the antennas substantially comprises a “u-shaped” can be employed. As another non-limiting example, a clover leaf configuration of an antenna in the antenna array can be used.

A positive side-effect to utilizing any compensated antenna configuration described herein is that the current direction of the turns in each antenna is substantially identical, thereby generating a higher magnetic field strength in a concentrated area. This enhanced field strength can result in improved read ranges and/or improved read accuracy.

In accordance with at least some embodiments of the present disclosure an antenna array for use in connection with an RFID reader is provided. The antenna array may be incorporated in the RFID reader or may be remote from the RFID reader. In some embodiments, the antenna array comprises a first antenna tuned to operate at a first carrier frequency and a second antenna tuned to operate at a second carrier frequency that is different from the first carrier frequency, where the first antenna is positioned within the second antenna and overlaps itself at at least one point such that at least some induced current in the first antenna is offset by at least some induced current in the second antenna and such that at least some induced current in the second antenna is enhanced at the at least one point of overlap.

In some embodiments, the first antenna corresponds to a low frequency antenna and the second antenna corresponds to a high frequency antenna. In some embodiments, the first antenna corresponds to a high frequency antenna and the second antenna corresponds to a low frequency antenna. In other words, certain antenna array configurations may provide the high frequency antenna within the low frequency antenna while other antenna array configurations may provide the low frequency antenna within the high frequency antenna. Furthermore, embodiments of the present disclosure may provide antennas that operate at carrier frequencies other than traditional low (125 kHz) and high (13.56 MHz) frequencies. For instances, antennas can be tuned to operate at ultra-high frequencies (UHF), microwave frequencies, or any other frequency within the electromagnetic spectrum.

The present invention will be further understood from the drawings and the following detailed description. Although this description sets forth specific details, it is understood that certain embodiments of the invention may be practiced without these specific details. It is also understood that in some instances, well-known circuits, components and techniques have not been shown in detail in order to avoid obscuring the understanding of the invention.

### BRIEF DESCRIPTION OF THE DRAWINGS

The present disclosure is described in conjunction with the appended figures:

FIG. 1A is a block diagram depicting a first RFID system configuration in accordance with embodiments of the present disclosure;

FIG. 1B is a block diagram depicting a second RFID system configuration in accordance with embodiments of the present disclosure;

FIG. 2 is a block diagram depicting a first antenna array configuration in accordance with embodiments of the present disclosure;

FIG. 3 is a block diagram depicting current flow directions through the first antenna array configuration depicted in FIG. 2;

FIG. 4 is a block diagram depicting a second antenna array configuration in accordance with embodiments of the present disclosure; and

FIG. 5 is a block diagram depicting a third antenna array configuration in accordance with embodiments of the present disclosure.

### DETAILED DESCRIPTION

Embodiments of the present disclosure will be described in connection with an RFID reader used in an RFID system, such as an access control system. It should be appreciated, however, that embodiments of the present disclosure may be applied to non-RFID systems and other communication systems. Furthermore, the systems or devices which employ the concepts disclosed herein do not necessarily have to be utilized in an access control system. Instead, embodiments of the present disclosure can be leveraged in supply chain management systems, inventory systems, physical access control systems, logical access control systems, combinations thereof, and the like.

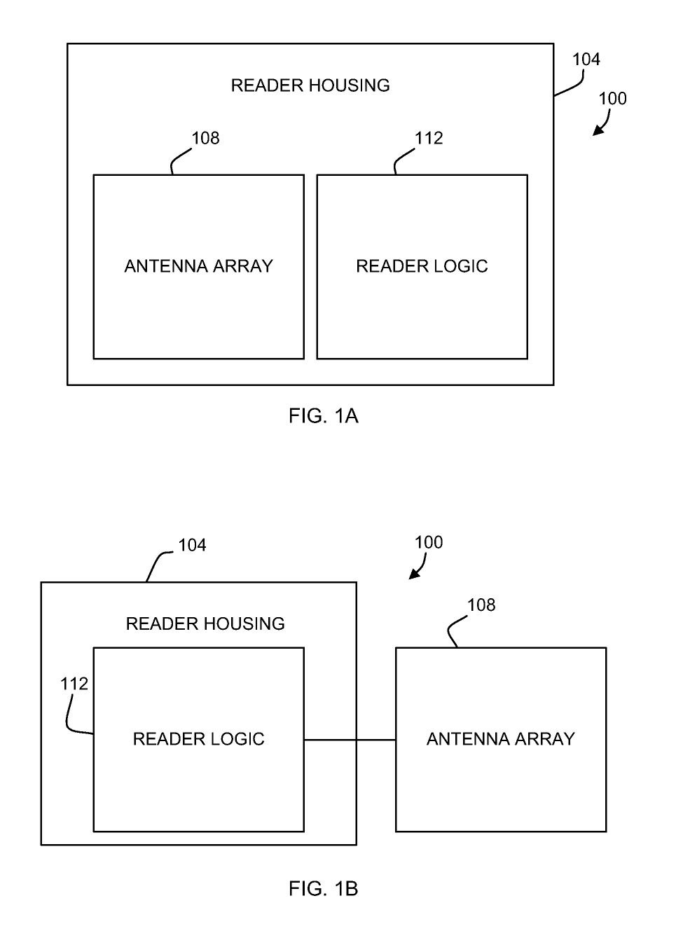

With reference now to FIGS. 1A and 1B, an illustrative RFID system 100 will be described in accordance with embodiments of the present disclosure. The system 100 comprises an RFID reader 104, an antenna array 108, and reader logic 112. As depicted in FIG. 1A, the reader logic 112 and antenna array 108 may both reside within a common housing (e.g., plastic and/or metallic enclosure) of the reader 104. Conversely, as depicted in FIG. 1B, the reader logic 112 may reside in the housing of the reader 104 while the antenna array 108 may reside external to the housing of the reader 104. When the antenna array 108 is external to the housing of the reader 104, then one or more communication channels or lines may connect the reader logic 112 with the antenna array 108. Suitable communication channels or lines that may connect the reader logic 112 to an external antenna array 108 include, without limitation, RS232, Ethernet, Wi-Fi (e.g., 802.11N, variants thereof, or extensions thereto), Bluetooth, etc.

In some embodiments, the antenna array 108 may comprise one or more antenna drivers (e.g., analog and/or digital circuitry used to provide power to the antennas, modulate signals on the antenna, demodulate signals received at the antennas, etc.). In some embodiments, the drivers may be provided in the reader logic 112. In some embodiments, some portions of the drivers may be provided in the antenna array 108 while other portions of the drivers may be provided in the reader logic 112.

The antenna array 108 may comprise one or more antennas that are configured to exchange data with RFID credentials or tags. In some embodiments, the antenna array 108 may be configured to exchange data with passive credentials (e.g., credentials without a power source) by inductive coupling. In some embodiments, the antenna array 108 may be configured to exchange data with active credentials (e.g., credentials with a power source). In some embodiments, the antenna array 108 may enable the reader 104 to exchange communications with a credential or a plurality of credentials in accordance with a well-known communication standard, such as ISO 14443, ISO 15693, ISO 18092, FeliCa, Near Field Communications (NFC), Bluetooth, Wi-Fi, ZigBee, GSM, variants thereof, or extensions thereto. While the reader 104 may have other components that enable it to communicate with tags via non-magnetic inductive coupling (e.g., contact-based mechanisms, capacitive-based mechanisms, optical-based mechanisms, acoustic-based mechanisms, etc.), the antenna array 108 enables the reader to exchange data with an RFID credential or tag via inductive coupling.

More precisely, each antenna in the antenna array 108 may comprise the ability to communicate with one or more different types of transponders. For instance, the antenna array 108 may comprise a plurality of antennas, where each antenna is configured to communicate with RFID credentials at a different frequency. The operational frequency of an antenna in the antenna array 108 may refer to the carrier frequency or the frequency at which the antenna is tuned such that it can inductively couple with an RFID credential that is also appropriately tuned to the same operational or resonant frequency. As can be appreciated, the physical characteristics of the antenna may at least partially determine the operational frequency of an antenna. Additionally, the configuration of the antenna driver may at least partially determine the operational frequency of an antenna.

In some embodiments, the antenna array 108 may simply comprise a plurality of different antennas that are compensated for simultaneous and/or close proximity operation. Specifically, it is known that parasitic capacitances, among other phenomena, may occur between two antennas operating in close proximity to one another. This parasitic capacitance between antennas causes interference between the antennas, which may ultimately reduce the read range of the reader 104 or the accuracy with which credentials can be read. The RFID antennas of the antenna array 108 are generally configured to have a read range between 0.01 m and 10 m (most often between 0.1 m and 0.3 m). If the parasitic capacitance between the antennas is not taken into account, the read range of the reader can be reduced by more than half or the number of false or incomplete reads can be greatly increased.

It is, therefore, one aspect of the present disclosure to provide antennas within the antenna array 108 that are specifically compensated for each other's operational frequencies. As a non-limiting example, consider a multi-technology RFID reader that has one antenna in the antenna array 108 operating to read credentials of a first type (e.g., low frequency RFID credentials operating nominally at 125 kHz) and another antenna in the antenna array 108 operating to read credentials of a second type (e.g., high frequency RFID credentials operating nominally at 13.56 MHz). These two antennas, when operating in close proximity to one another, may interfere with each other's operations.

The reader logic 112 may comprise any combination of hardware and software components suitable for controlling operations of the reader 104. The reader logic 112, in some embodiments, may comprise one or more of hardware, software, an Application Specific Integrated Circuit (ASIC), firmware, middleware, and combinations thereof.

In operation, the reader logic 112 may cause the antenna array 108 to normally operate in a “ping” or search mode where low power pulses of energy are sequentially supplied to each antenna in the antenna array. As an example, the reader logic 112 may excite a first antenna to search for a first type of credential operating at a first frequency, if no such credential is detected then excite a second antenna to search for a second type of credential operating at a second frequency, if no such credential is detected then excite either the first antenna again or a third antenna to search for a third type of credential operating at a third frequency, etc. During this search mode, the reader logic 112 is searching for RFID credentials within a read range of the antenna array 108. When a credential of a certain type is detected with one of the antennas, then the reader logic 112 switches into a read mode where the antenna that was used when the credential was detected within a read range is driven with a higher current to enable the antenna to exchange data with the detected credential. This type of ping and read functionality is discussed in further detail in U.S. Pat. No. 8,063,746 to Borcherding, the entire contents of which are hereby incorporated herein by reference.

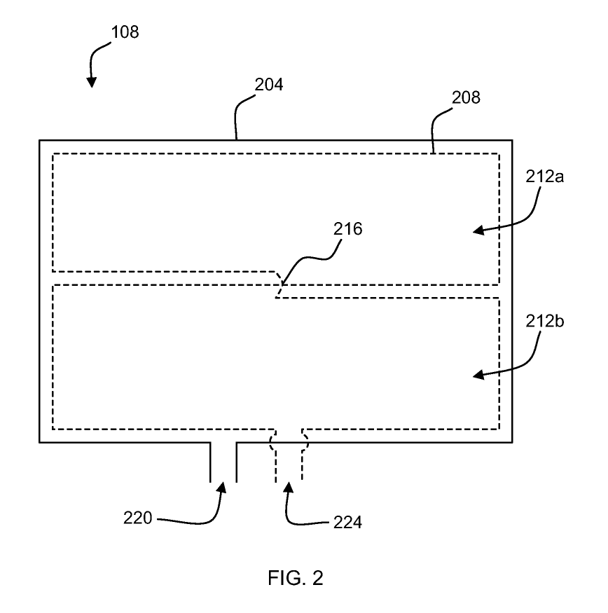

FIGS. 2-5 depict various examples of an antenna array 108 that overcomes many of the problems associated with operating multiple antennas in close proximity to one another (e.g., within 0.1 m or less of one another). While the examples depicted and described herein show the antenna array 108 as comprising two antennas, it should be appreciated that a compensated antenna array 108 may be equipped with three, four, five, or more antennas, each of which may operate at the same or different frequencies by following one or more of the general principles disclosed herein. Additionally, although each of the examples depict the antennas of the antenna array as being substantially co-planar (e.g., established in a common plane or mounted on a common surface), it should be appreciated that embodiments of the present disclosure are not so limited. For instance, an antenna array 108 may comprise two antennas having a configuration similar to a configuration depicted and/or described herein, but the antennas may be mounted on different planes, which may or may not be parallel with one another. As a non-limiting example, a first antenna may be mounted on a first substrate, then that substrate and the first antenna may have a second substrate mounted thereon. A second antenna may then be mounted on the second substrate so that it is separated from the first antenna by the first substrate. As another non-limiting example, a first antenna may be mounted on a first surface of a substrate while a second antenna may be mounted on an opposing second surface of the substrate such that the antennas are mounted in different planes but where the planes are substantially parallel with one another.

Furthermore, many of the concepts disclosed herein provide a configuration whereby the magnetic flux generated by one antenna at least partially cancels or opposes the magnetic flux of another antenna in the antenna array. Details of an opposing magnetic flux arrangement are further described in U.S. Pat. No. 7,439,862 to Quan, the entire contents of which are hereby incorporated herein by reference. It should be appreciated that this opposing magnetic flux arrangement can be achieved by offsetting the planes on which antennas are mounted, shifting one antenna relative to another so that the antennas partially overlap and/or partially do not overlap, mounting one antenna within or inside another antenna, or combinations thereof. Any of the antenna arrays 108 disclosed herein can be configured or altered to further enhance this opposing magnetic flux arrangement. In other words, a first antenna may be configured to produce a magnetic flux in a first direction within the winding of the antenna. A second antenna in the antenna array 108 may be positioned such that at least some flux produced thereby passes through the first antenna in a direction opposite to the magnetic flux produced by the first antenna. This opposing magnetic flux arrangement can be achieved with any of the array 108 designs disclosed herein alone, in combination with each other, or in combination with any of the array designs disclosed in the '862 patent.

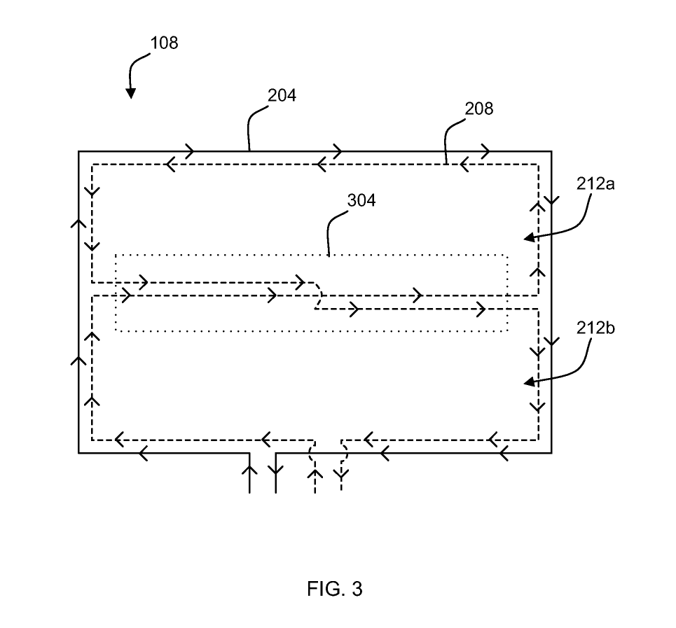

Referring now to FIGS. 2 and 3, a first possible configuration of an antenna array 108 will be described in accordance with at least some embodiments of the present disclosure. The antenna array 108 depicted in FIGS. 2 and 3 comprises a first antenna 204 and a second antenna 208. The first antenna 204 is depicted as comprising a circular, zero, or non-overlapping loop arrangement. The second antenna 208 is depicted as comprising an overlapping loop arrangement—specifically a figure-eight arrangement.

The first antenna 204 comprises a connecting portion 220 and the second antenna 208 also comprises a connecting portion 224. The connecting portions 220, 224 may correspond to parts of the antenna that generally do not contribute to the creation of a magnetic flux (e.g., are not a part of the coil or winding of the antenna). The connecting portions 220, 224 may also be referred to as leads and may be connected to other circuitry such as antenna driver circuitry and/or the reader logic 112.

The first antenna 204 may comprise up to N windings, where N is any number greater than or equal to one. In some embodiments, the first antenna 204 may not even complete a single winding or loop because it may be configured to end the loop before wrapping completely back around to itself (e.g., as depicted in FIGS. 2 and 3). Moreover, the number of windings does not have to be an integer value. Instead, the first antenna 204 may comprise fractional portions of a winding by having one of its leads in the connecting portion 220 terminate on one side of the loop and by having another one of its leads in the connecting portion 220 terminate on a different side of the loop.

The second antenna 208 may similarly comprise up to N windings, where N is any number greater than or equal to one. As with the first antenna 204, the second antenna may not even complete a single winding or loop and the number of windings does not have to be an integer value.

The second antenna 208 is depicted as being set or mounted inside the winding of the first antenna 204. It should be appreciated, however, that the first antenna 204 may be mounted outside of the second antenna 208, either partially or completely. Furthermore, the first antenna 204 and second antenna 208 may be mounted directly over or on top of one another.

The antennas 204, 208 may comprise wires that have been looped or wound to have the configuration shown. Alternatively or additionally, the antennas 204, 208 may comprise conductive ink that has been printed or otherwise deposited on a substrate. Stated another way, the antennas 204, 208 may be manufactured according to any known or yet to be developed antenna manufacturing technique.

In some embodiments, the first antenna 204 may be configured to communicate with a first type of credential while the second antenna 208 may be configured to communicate with a second different type of credential. More specifically, the first antenna 204 may be configured or tuned to communicate at a high carrier frequency, such as about 13.56 MHz while the second antenna 208 may be configured or tuned to communicate at a low carrier frequency, such as about 125 kHz. Thus, the first antenna 204 may also be referred to as a high frequency antenna while the second antenna 208 may be referred to as a low frequency antenna. Of course, the first antenna 204 may correspond to a low frequency antenna while the second antenna 208 may correspond to a high frequency antenna. In other embodiments, one of the antennas 204, 208 may be configured to operate at some frequency other than 125 kHz or 13.56 MHz. For instance, one or both of the antennas 204, 208 may be configured or tuned to operate at UHF, microwave frequencies, or any other frequency.

As can be seen in FIG. 3, the overlapping loop arrangement of the second antenna 208 may result in the creation of an enhanced field strength area 304. Specifically, the second antenna 208 comprises a first loop portion 212a and a second loop portion 212b with at least one overlapping point 216 therebetween. The first loop portion 212a and second loop portion 212b are depicted as having a shared boundary or border where current flowing (depicted by the arrows of FIG. 3) in each loop has an additive effect at the shared border. This area where the currents in each loop portion 212a, 212b become additive is referred to as the enhanced field strength area 304. When the antenna array 108 is mounted inside of the reader housing 104, the enhanced field strength area 304 may be positioned at a point or area of the reader housing 104 where credentials are to be presented (approximately) for reading/writing.

Although the overlapping point 216 is depicted as being in substantially the center of the first antenna 204, it should be appreciated that the location of the overlapping point 216 can occur anywhere within the first antenna 204. In some embodiments, the overlapping point 216 may be positioned more closely to the connecting portions 220, 224. In other embodiments, the overlapping point 216 may be positioned toward an outer edge of the first antenna 204. In some embodiments, the overlapping point 216 corresponds to a bridge or the like where the conductive component of the antenna overlaps itself at least once.

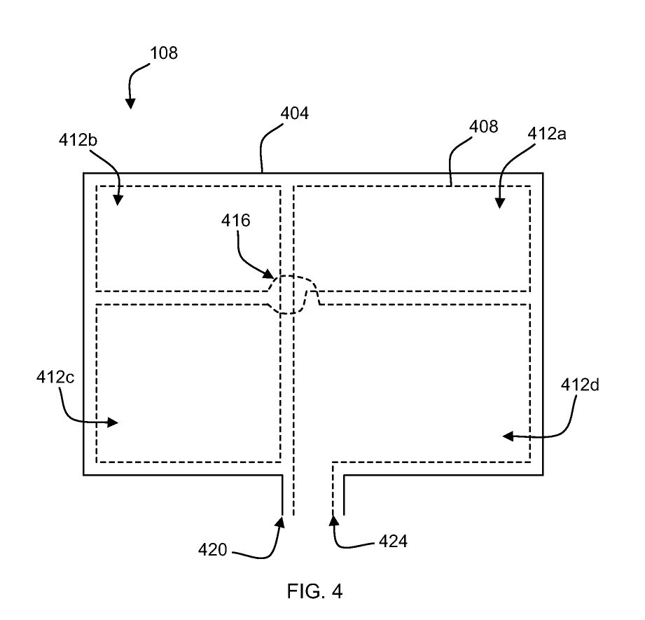

With reference now to FIG. 4, a second possible configuration for an antenna array 108 will be described in accordance with at least some embodiments of the present disclosure. The antenna array 108 comprises a first antenna 404 and second antenna 408. The first antenna 404 may comprise a shape that is similar or identical to the shape or configuration of the first antenna 204 depicted in FIG. 2.

The second antenna 408 is depicted as comprising a cloverleaf configuration such that it comprises a plurality of loop sections 412a-d and one or more overlapping points 416. In the depicted embodiment, the second antenna 408 is configured such that the overlapping points 416 are in approximately the same location. In other embodiments, some of the overlapping points 416 may be separated from one another. Furthermore, the size of each loop section 412a-d may be the same or different.

The antennas 404, 408 may comprise connecting portions 420, 424. The connecting portion 424 of the second antenna 408 may be mounted inside the connecting portion 420 of the first antenna 404. In other embodiments, the connecting portion 420 of the first antenna 420 may be mounted inside the connecting portion 424 of the second antenna 408.

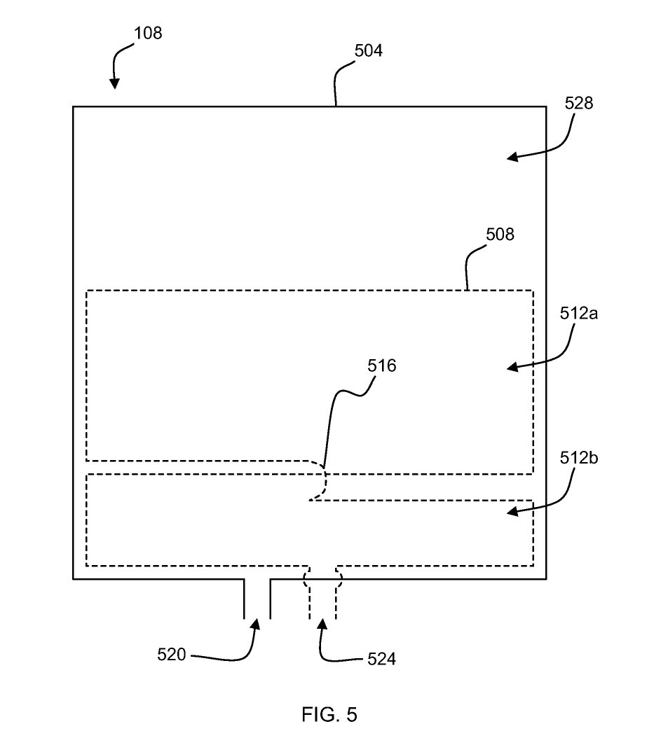

With reference now to FIG. 5, still another possible configuration of an antenna array 108 will be described in accordance with at least some embodiments of the present disclosure. The antenna array 108 comprises a first antenna 504 and second antenna 508. The first antenna 504 may correspond to a high frequency antenna while the second antenna 508 may correspond to a low frequency antenna. In other embodiments, the first antenna 504 may correspond to a low frequency antenna while the second antenna 508 may correspond to a high frequency antenna.

The antenna array 108 configuration of FIG. 5 is similar to the configuration of FIGS. 2 and 3 except that the second antenna 508 has asymmetrically sized loop portions 512a, 512b and there is an open area 528 within the first antenna 504. The open area 528 within the first antenna 504 may correspond to a location where other electronics may be mounted. For example, the antennas 504, 508 may be established on a PCB or similar substrate and some of the electronics for driving the antennas may be mounted in the open area 528. As an example, an Integrated Circuit (IC) chip or similar hardware components may be mounted in the open area 528.

Each antenna 504, 508 may comprise a connecting portion 520, 524 and the second antenna 508 may comprise a figure-eight configuration with at least one overlapping point 516. In the depicted example, the second antenna 508 comprises a first loop portion 512a that is larger than its second loop portion 512b. Tests and simulations have shown that the asymmetric proportions of the loop portions 512a, 512b can be specially configured to maximize a read range of the reader 104. In some embodiments, an optimum read distance can be obtained for both antennas 504, 508 when the configuration of FIG. 5 is used and when a size of the second loop portion 512b is between one half (½) and one third (⅓) a size of the first loop portion 512a.

A size of the second antenna 508 relative to the first antenna 504 may also be adjusted to accommodate electronics of varying size. Specifically, if electronics of a particular size are desired, then the size of the open area 628 may be adjusted to accommodate the desired electronics. Of course, a size of the open area 628 may be weighed against a desired overall size of the reader housing 104.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. An antenna array for an RFID reader comprising:
a first antenna tuned to operate at a first carrier frequency;
a second antenna tuned to operate at a second carrier frequency that is different from the first carrier frequency, wherein the first antenna is positioned within the second antenna and overlaps itself at least one point such that at least some induced current in the first antenna is offset by at least some induced current in the second antenna and such that at least some induced current in the second antenna is enhanced at the at least one point of overlap.

2. The antenna array of claim 1, wherein the first antenna comprises a first loop portion and a second loop portion.

3. The antenna array of claim 2, wherein the first loop portion and the second loop portion are arranged in a figure-eight configuration.

4. The antenna array of claim 2, wherein the first antenna further comprises a third loop portion and a fourth loop portion.

5. The antenna array of claim 4, wherein the first, second, third, and fourth loop portions are arranged in a cloverleaf configuration.

6. The antenna array of claim 2, wherein the first loop portion is asymmetrically proportioned with respect to the second loop portion.

7. The antenna array of claim 6, wherein the first loop portion comprises an area that is between about ½ and ⅓ an area of the second loop portion.

8. The antenna array of claim 1, wherein the first carrier frequency is lower than the second carrier frequency.

9. The antenna array of claim 1, wherein the first carrier frequency is approximately 125 kHz and the second carrier frequency is approximately 13.56 MHz.

10. The antenna array of claim 1, wherein an open area is provided within the second antenna and external to the first antenna and wherein the open area is configured to receive electronics.

11. The antenna array of claim 1, wherein the first and second antennas are arranged in an opposing magnetic flux arrangement.

12. An RFID system comprising the antenna array of claim 1.

13. The RFID system of claim 12, further comprising reader logic configured to control operations of the RFID reader.

14. The RFID system of claim 13, wherein the reader logic and antenna array are both contained within a common reader housing.

15. A multi-technology reader, comprising:
an antenna array, the antenna array comprising a first antenna and a second antenna, the first antenna being positioned within the second antenna and overlapping itself at at least one point such that at least some induced current in the first antenna is offset by at least some induced current in the second antenna and such that at least some induced current in the second antenna is enhanced at the at least one point of overlap; and
reader logic configured to operate the antenna array.
